(19) United States
(12) Patent Application Publication
(10) Pub. No.: US 2008/0292506 A1
(43) Pub. Date: Nov. 27, 2008

(54) Test tube

(75) Inventor: Teruaki Itoh, Kumamoto-shi (JP)

Correspondence Address: NIXON & VANDERHYE, PC, 901 NORTH GLEBE ROAD, 11TH FLOOR, ARLINGTON, VA, 22203, US

(73) Assignee: IDS CO., LTD., Kumamoto-shi (JP)

(21) Appl. No.: 12/153,491

(22) Filed: May 20, 2008

(30) Foreign Application Priority Data
May 21, 2007 (JP) 2007-134571

(51) Int. Cl. B01L 3/14

(52) U.S. Cl. 422/102

(57) ABSTRACT

A test tube includes a barcode indicative of identification information. The barcode is printed directly on an outer peripheral surface of a barrel of a test tube body by an inkjet printer.

### CROSS-REFERENCE TO RELATED APPLICATIONS

This application is based upon and claims the benefit of priority from prior Japanese Patent Application No. 2007-134571, filed May 21, 2007, the entire contents of which are incorporated herein by reference.

### BACKGROUND OF THE INVENTION

1. Field of the Invention

The present invention relates to a test tube configured to contain a specimen, such as blood.

2. Description of the Related Art

A test tube that contains a specimen, such as blood, is a transparent glass or plastic tube fitted with a rubber or plastic cap on its top opening. An identification label is stuck on the barrel of the test tube. A barcode indicative of identification information and characters that represent a date of blood collection, place of blood collection, patient's name, etc., are printed on the identification label.

A test tube labeling apparatus that sticks identification labels on test tubes is described in, for example, Jpn. Pat. Appln. KOKAI Publication No. 2006-56568 (Patent Document 1). FIG. 3 shows a configuration of this labeling apparatus. A labeling position 3 is provided in the middle of a conveyor 2 that conveys a test tube 1. A labeling mechanism 5 including a labeling roller 4 is disposed in the labeling position 3. Further, a test tube retaining mechanism 6 is located over the labeling position 3 so that it can retain the test tube 1 in a vertical state. The retaining mechanism 6 includes a lift cylinder 7. A test tube insert head 9 to be inserted into the test tube 1 is disposed on the distal end portion of a rod 8 of the lift cylinder 7.

If the test tube 1 that is retained by the test tube insert head 9 of the test tube retaining mechanism 6 is fed in a vertical state into the labeling position 3 as the lift cylinder 7 descends, the labeling roller 4 of the labeling mechanism 5 rotates, whereupon an identification label 10 is laterally supplied to the labeling position 3 and pasted on the barrel of the test tube 1.

A barcode indicative of identification information and characters that represent a date of blood collection, place of blood collection, patient's name, etc., are printed on the identification label 10 and read by a barcode reader.

An identification label that is stuck on a test tube is also described in Jpn. Pat. Appln. KOKAI Publication No. 8-166765 (Patent Document 2). An adhesive agent on the reverse side of this label is pasted on the outer peripheral surface of the barrel of the test tube.

Conventionally, as described in Patent Documents 1 and 2, an identification label that bears a barcode indicative of identification information and characters that represent the date and place of blood collection, patient's name, etc., is stuck on the outer peripheral surface of the barrel of a test tube. More specifically, the barcode indicative of the identification information and the characters that represent the date and place of blood collection, patient's name, etc., is previously printed on the obverse surface of the identification label that has the adhesive agent on its reverse surface. The identification label on which the predetermined information is printed in this manner is stuck on the test tube.

Thus, the labeling apparatus for sticking the identification label with the predetermined information thereon on the test tube is required as well as a printer for printing the information on the label, so that the equipment cost is inevitably high.

### BRIEF SUMMARY OF THE INVENTION

According to an aspect of the invention, a test tube comprises a barcode indicative of identification information. The barcode is printed directly on an outer peripheral surface of a barrel of a test tube body by means of an inkjet printer.

According to another aspect of the invention, a barcode indicative of identification information and characters which represent a date of blood collection, place of blood collection, patient's name, etc., are printed directly on an outer peripheral surface of a barrel of a test tube body by means of an inkjet printer.

According to another aspect of the invention, the barcode and characters are printed along an axis of the test tube body. The characters represent the date of blood collection, place of blood collection, patient's name, etc. The characters are printed on one or both sides of the barcode.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a test tube according to a first embodiment of the present invention;

FIG. 2A is a front view showing a handheld inkjet printer of the same embodiment;

FIG. 2B is a side view showing a handheld inkjet printer of the same embodiment; and

FIG. 3 is a side view showing a conventional test tube labeling apparatus.

### DETAILED DESCRIPTION OF THE INVENTION

An embodiment of the present invention will now be described with reference to the accompanying drawings.

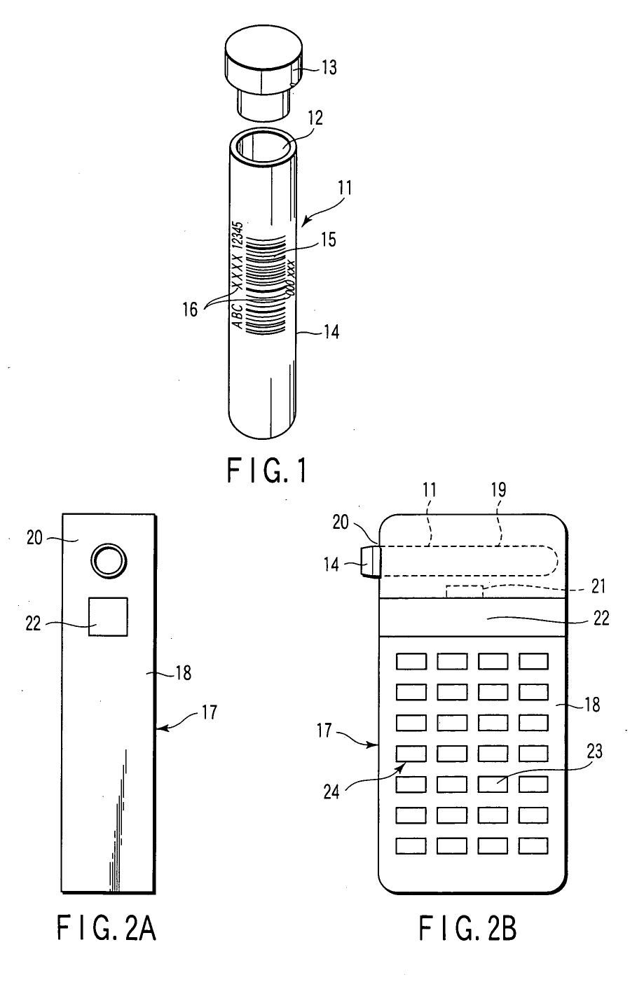

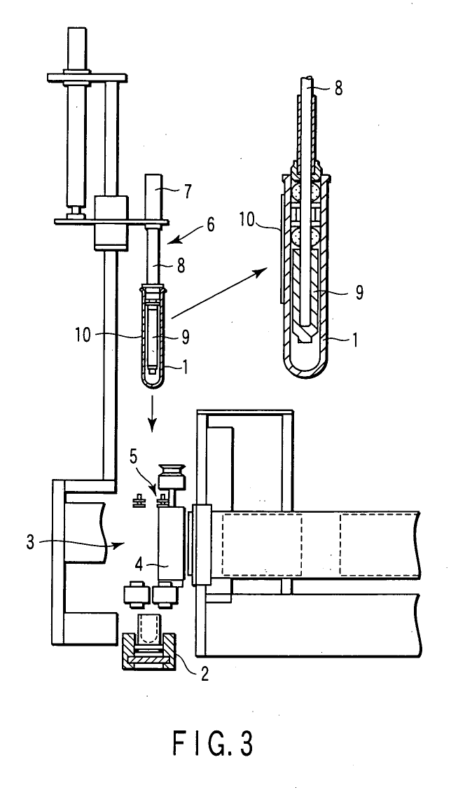

FIG. 1 shows a first embodiment, in which a cylindrical test tube body 11 that contains a specimen, such as blood, is a transparent glass or plastic structure. A rubber or plastic cap 13 is attached to a top opening 12 of the body 11. A barcode 15 that indicates identification information is printed on the outer peripheral surface of a barrel 14 of the test tube body 11. The barcode 15 is printed along the axis of the test tube body 11. Characters 16 that indicate date of blood collection, place of blood collection, patient's name, etc., are printed directly on one or both sides of the barcode 15. In general, an identification label on which a barcode indicative of identification information is printed is stuck on the test tube body 11. On the other hand, the present invention is characterized in that the identification information is printed directly on the outer peripheral surface of the barrel 14 of the test tube body 11.

Preferably, the barcode 15 and the characters 16, which represent the date and place of blood collection, patient's name, etc., are printed directly on the barrel 14 of the test tube body 11 by means of a handheld inkjet printer 17, such as the one shown in FIG. 2, which uses quick-dry stamp ink “Aeroink (Japanese trademark)”.

The handheld inkjet printer 17 is provided with a test tube holding portion 19 on an upper part of its main body 18, which is of a size such that it can be grasped by, for example, the left hand. The holding portion 19 has a test tube inlet 20 on one side portion of the printer body 18. The test tube body 11 can be set in the holding portion 19 by being inserted into it with its bottom side forward. The holding portion 19 is adjoined by a printing mechanism section 22, which is provided with an inkjet head 21. The inkjet head 21 can axially scan the test tube body 11 to print the barcode 15 indicative of the identification information and the characters 16, which represent the date and place of blood collection, patient's name, etc., directly on the outer peripheral surface of the barrel 14 of the test tube body 11.

Further, a keyboard 24 that is provided with a large number of keys 23 is disposed on the front surface of the printer body 18. If the identification information to be printed is input with the keyboard 24 as signals to the printing mechanism section 22, the section 22 can print the designated barcode 15 and the characters 16, which represent the date and place of blood collection, patient's name, etc., directly on the test tube body 11. Thus, optional information can be printed on each individual test tube body 11 before or after blood collected from a patient is injected into the test tube body 11. Further, human-error, such as conventional erroneous labeling, can be prevented.

The above is a description of the handheld inkjet printer 17 configured to print the information on the test tube bodies 11 that are inserted one after another into the printer body 18. However, the present invention is not limited to this configuration of the inkjet printer, but is also applicable to a large, high-processing inkjet printer that can continuously print information on a large number of test tubes that are automatically supplied to a printing mechanism section.

Although the test tubes according to the foregoing embodiment have been described as being configured to contain blood, the present invention is also applicable to printing on containers (test tubes) that contain medicines, food test samples, etc., as well as test tubes that are used in biopsy for collected samples of blood, urine, tissue, etc.

According to the present invention, the barcode indicative of the identification information is printed directly on the outer peripheral surface of the barrel of the test tube body by means of the inkjet printer. Thus, there is no need of a printer for identification label printing or a labeling apparatus for sticking identification labels on test tubes, so that the equipment cost can be reduced considerably. Further, specimens can be quickly prepared by obviating a process for sticking identification labels on test tubes.

The present invention is not limited directly to the embodiment described above, and its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A test tube comprising a barcode indicative of identification information, wherein the barcode is printed directly on an outer peripheral surface of a barrel of a test tube body by means of an inkjet printer.

2. A test tube comprising a barcode indicative of identification information and characters which represent a date of blood collection, place of blood collection, patient's name, etc., wherein the barcode and characters are printed directly on an outer peripheral surface of a barrel of a test tube body by means of an inkjet printer.

3. A test tube according to claim 1, wherein the barcode is printed along an axis of the test tube body, and the characters which represent the date of blood collection, place of blood collection, patient's name, etc., are printed on one or both sides of the barcode.
